(19) United States
(12) Patent Application Publication
(10) Pub. No.: US 2022/0312106 A1
(43) Pub. Date: Sep. 29, 2022

(54) NOISE GENERATOR

(71) Applicant: Hewlett-Packard Development Company, L.P., Spring, TX (US)

(72) Inventor: Ryan Henry Cadwallader, Redmond, WA (US)

(73) Assignee: Hewlett-Packard Development Company, L.P., Spring, TX (US)

(21) Appl. No.: 17/615,600

(22) PCT Filed: Sep. 20, 2019
(86) PCT No.: PCT/US2019/052179

§ 371 Date: Dec. 1, 2021

(51) Int. Cl. H04R 1/10; G10K 11/178

(52) U.S. Cl. CPC H04R 1/1083; H04R 1/1008; G10K 11/17857; G10K 11/17881; H04R 2201/107; H04R 2460/01; G10K 2210/1081

(57) ABSTRACT

An example audio system includes a boom arm, a microphone, a noise generator, a speaker, and an input/output circuit. The noise generator is electrically coupled to the microphone and generates an inverse audio signal corresponding to an input signal generated by the microphone. The speaker is electrically coupled to the noise generator and generates an acoustic wave based on the inverse audio signal. The speaker is located on a same end of the boom arm as the microphone

### BACKGROUND

Portable electronic computing devices allow for teleconferencing from any location that provides network access. A remote teleconference attendee may use a headset with a microphone to capture the attendee's voice for other attendees to hear and earphones to produce the conversation from the other attendees to be heard by the remote attendee.

### BRIEF DESCRIPTION OF THE DRAWINGS

FIGS. 1 and 2 are block diagrams depicting example audio systems.

FIG. 3 is a front view of an example audio system worn by a user.

FIG. 4 is a top view of the example audio system of FIG. 3.

FIG. 5 is a side view of the example audio system of FIG. 3.

FIG. 6 is a front view of an example audio system worn by a user.

### DETAILED DESCRIPTION

In the following description and figures, some example implementations of audio apparatus, audio systems, and/or methods providing audio are described. An audio apparatus may be an audio device, such as a headset. A headset, as used herein, represents any audio system that makes contact with a portion of the head of a user. For example, a headset may be headphones with a left and right earphone covering and/or in contact with a user's ears. In another example, a headset may have a single earphone and a microphone boom attached to the single earphone housing.

Headsets are generally used during office telephonic conversations or using a conferencing service hosted by a computer device. While portable electronic devices allow for teleconferencing from various locations, such locations may include a distracting amount of background noise and may allow other people to potentially overhear conversations. It may be desirous to keep some conversations confidential at locations where the user cannot completely isolate themselves from others.

Some audio systems provide noise control features; however, it is difficult to perform analysis and compensate for noise when the noise source is located away from the source of the noise analysis. Indeed, there is a relationship between fidelity of noise signals being captured and the distance from the source at which the sounds are captured. This may be particularly true for sounds that are quiet relative to ambient noise level, such as when someone is trying to whisper. Indeed, many noise control features by electronic devices, such as placed in the middle of a conference room, have attempted to improve sound quality through noise cancellation, but have had little success in reducing ambient noise due to the difficulty in distinguishing between ambient noise sounds and targeted conversation or other sounds desired to be emphasized.

Various examples described below relate to placing a noise control feature near the source of a voice signal. By placing a microphone near a sound source and a speaker near the microphone, an acoustic wave may be generated to reduce or distort the sound from the source. Electrically, a speaker could be wired to a microphone that a user speaks into, and a signal from the microphone may be sent to the speaker would be inverted (and potentially with white noise introduced to the signal) so the sounds coming from the user's mouth are reduced and/or distorted by the sounds coming from the speaker, for example. The signal being played from the noise control speaker may also be processed by noise cancellation circuitry in a pair of headphones so that the user does not hear the garbled voice through their headphones. Indeed, by placing noise control circuitry (e.g., noise cancellation circuitry and/or noise generation circuitry) near the microphone source, source fidelity may be improved by reducing noise pollution at the noise source, as an example.

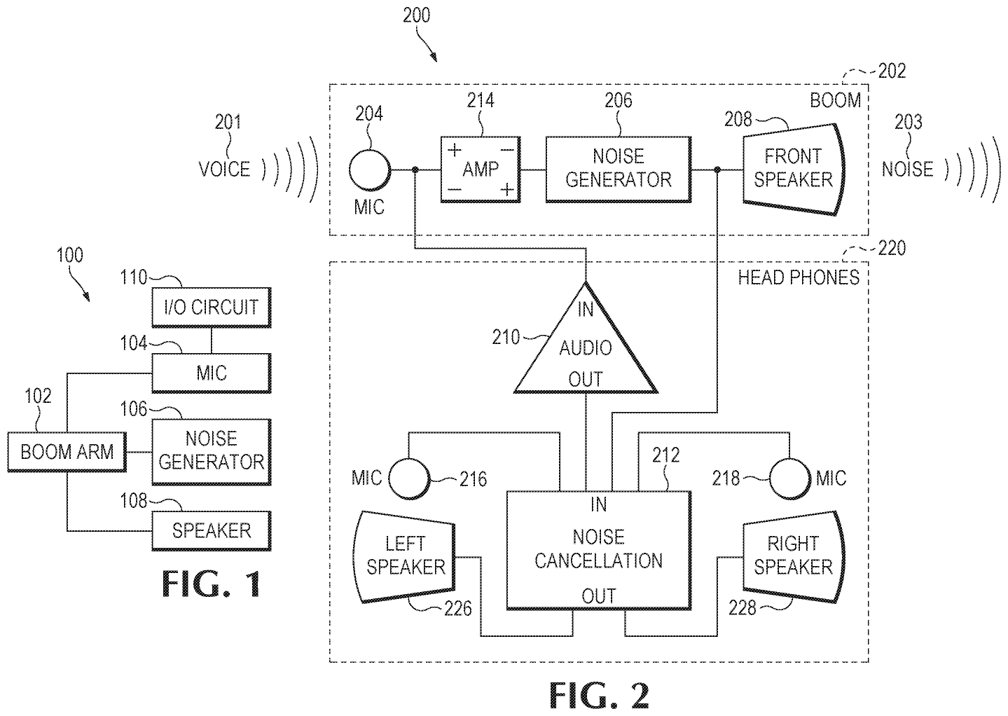

FIGS. 1 and 2 are block diagrams depicting example audio systems 100 and 200. Referring to FIG. 1, an example audio system 100 may include a boom arm 102, a microphone 104, a noise generator 106, a speaker 108, and an input/output (I/O) circuit 110. In general, the speaker 108 is caused to generate noise from a signal generated by the noise generator 106 based on an input signal received by the microphone 104.

The boom arm 102 represents a mechanical support on which to place the microphone 104 and the speaker 108. In an example, the boom arm 102 may be a bendable, yet supportive structure having electrical cabling routed through it towards an end of the boom arm 102 where the microphone 104 and the speaker 108 are located. The microphone 104 and the speaker 108 may be located on the same end or portion of the boom arm 102 and may be located on substantially opposing sides of the boom arm portion on which they are located. For example, this may allow the speaker to produce an acoustic wave in substantially the same direction as the sound received by the microphone 104. Such an example is depicted further with respect to FIG. 4.

The microphone 104 is coupled to the boom arm 102, such as in a location to be positioned directly in front of a user's mouth. The microphone 104 represents circuitry that generates an input signal based on audio input (e.g., acoustic waves) captured by an audio sensor of the circuitry. For example, the microphone 104 may be a transducer to convert sound into an electrical signal.

The speaker 108 may be electrically coupled to the microphone 104 and the noise generator 106. The speaker 108 represents circuitry that generates an output signal based on audio input. For example, the speaker 108 may be an electric-acoustic transducer to convert an electrical audio signal to a corresponding sound or an electromechanical transducer to convert an electrical audio signal to a corresponding vibration. The speaker 108, when activated, generates an acoustic wave based on an audio signal, such as an inverse audio signal with respect to a voice input signal. Acoustic waves, as discuss herein, may include sound waves travelling through air or another medium, such as vibrations generated on a skull using bone-conducting speakers.

The speaker 108 may be located on a same end of the boom arm 102 as the microphone 104. The speaker 108 may be located at a substantially same position of the boom arm 102 as the microphone 104. Substantially, as used herein, refers to within 10% of the relative dimensions, such as within 10% of the length the boom 102 or within 10% of the angle of projection of the speaker. The microphone 104 may be located at the substantially same section of the boom arm 102 and the speaker 108 may be located or otherwise oriented in an orthogonal position with respect to the orientation of the microphone 104. The speaker 108 may be located a distance from the microphone that is less than the length of the boom arm 102, such as less than a quarter of the length of the boom arm 102. The cabinet of the speaker 108 may be small relative to the size of the boom arm 102 (e.g., less than the length of the boom arm) and may be larger than the size of a housing of the microphone 104. In an example, the microphone 104 and the speaker 108 may be integrated in the same housing together such that the microphone 104 and the speaker 108 may be physically located in a substantially same relative placement with respect to each other. For example, the speaker 108 may be physically coupled with the microphone 104 such that the two components maintain within a distance threshold (e.g., less than 1 inch, less than 0.25 inches, or less than 0.5 millimeters) from each other, such as to maintain audio fidelity, for example. For another example, the distance between the speaker 108 and the microphone 104 may be equal to or less than a dimension of a printed circuit board (PCB), such as the width of a PCB when circuitry of the microphone and circuitry of the speaker are mounted on the same PCB. For yet another example, the speaker and microphone combination may be centrally located with respect to positioning between two earphone speakers on a headset. By maintaining the physical location relationship of the speaker 108 and the microphone 104, any audio produced by the speaker 108 may maintain relative fidelity to the source of sound received by the microphone 104 because the speaker 108 will be as close to the source as possible (e.g., the speaker 108 will be about as close to the source as the microphone 104). Indeed, noise control operations may be optimized when performed very close (e.g., as close as possible) to the source of the sound (or if it is performed close to the human's ears receiving the sound), for example.

The noise generator 106 represents circuitry or a combination of circuitry and executable instructions that generate an inverse audio signal corresponding to an input signal generated by the microphone 104. A signal, as discussed herein, may represent a portion of a captured audio input signal, such as an audio input signal generated from acoustic waves. An audio signal may be any suitable type of signal that varies in frequency and/or amplitude content. A signal may be captured for a period of time and analyzed to identify signal characteristics, such as a frequency, an amplitude, etc. The noise generator 106 may include circuitry identifies an attribute of the signal characteristics and performs an inversion operation to invert the signal attribute, thus generating an invert signal (or counter signal with inversive qualities). For example, the noise generator 106 may generate a time-delayed signal with an amplitude inversion, such that when the time-delayed inverse signal is played at substantially the same time as the voice input, the acoustic waves of the voice input and the acoustic waves of the inverse signal may substantially merge to generate a reduced or garbled sound.

The noise generator 106 may include circuitry or a combination of circuitry and executable instructions that generate a noise audio signal in addition to the inverse audio signal, such as an audio signal that is different from the input signal from the microphone 104. This may be a noise audio signal that is a garbled version of the input audio signal from the microphone or a predetermined noise signal, such as a sound of a single tone or multiple tones of different pitch, white noise, an animal sound, music, a prerecorded message, a dynamically-generated message (e.g., make the recorded capture periods play backwards), etc. The speaker 108 may generate an audible sound that is different from the input signal and the acoustic wave based on a signal generated by the noise generator 106 where the audible sound generated by the speaker 108 using the signal of the noise generator 106 is louder than the decibel level of the input signal received by the microphone 104.

The I/O circuit 110 is coupled to the microphone 104. The I/O circuit 110 may be coupled to the speaker 108 and/or the noise generator 106. The I/O circuit 110 represents circuitry or a combination of circuitry and executable instructions that cause an input signal to be sent over a communication channel, such as an input voice signal to be sent over a communication channel to a conferencing service. For example, the I/O circuit 110 may compress signals corresponding to voice input received by the microphone 106 and send the compressed signals over a wireless connection to a host device hosting a video conferencing service. An example wireless connection may be a connection using BLUETOOTH protocol. In other examples, the connection may be wired.

Referring to FIG. 2, the example audio system 200 generally includes a boom 202 and headphones 220. The boom 202 of FIG. 2 includes a microphone 204, an amplifier 214, a noise generator 206, and a front speaker 208. The headphones 220 of FIG. 2 include an I/O circuit 210, a noise cancellation circuit 212, a left speaker 226, a right speaker 228, a left microphone 216, and a right microphone 218. The microphone 204, the noise generator 206, the front speaker 208, and the I/O circuit 210 of FIG. 2 represent the same components of the microphone 104, the noise generator 106, the speaker 108, and the I/O circuit 110 of FIG. 1, and, for brevity, their respective descriptions are not repeated in their entirety.

The first microphone 204 may include circuitry to generate a first input signal based on a first input acoustic wave generated from a first audio source. For example, the microphone 204 of the boom 202 may receive voice waves 201 and convert the voice waves 201 into an input signal.

The amplifier 214 may adjust the power of the signal generated by the microphone 204. For example, a first input signal may be amplified to a particular decibel level using the amplifier 214 and a first output acoustic wave is an audible sound having a decibel level above a decibel level threshold associated with the first input acoustic wave (e.g., above the particular decibel level of the first input signal). The amplified signal may be received by the noise generator 206.

The noise generator 206 may include signal analyzer circuitry to identify an acoustic wave characteristic associated with the input signal over a period of time. The capture periods analyzed by the noise generator 206 may be uniform or vary in duration of time between each capture period. A signal may be analyzed by the signal analyzer circuitry continuously, instantaneously, and/or over segmented portions of the signal. The signal analyzer circuitry may identify a decibel level of an input signal and the decibel level of a proposed output signal, and the noise generator 206 may cause the decibel level of the output signal to be greater than the decibel level of the input signal.

The signal analyzer circuitry of the noise generator 206 includes executable instructions to cause a signal analysis operation to perform on the first input signal. For example, noise generator 206 may include signal analyzer circuitry (or executable instructions) to cause a signal analysis operation to perform on the voice waves 201, identify parts of the voice waves 201 that are associated with words from a user, and generate an output signal corresponding to an inverse of the sounds of the words from the user at the time period when the words are desired to be cancelled. The signal analyzer circuitry may also identify what type of noise, if any, to generate in addition to the inverse signal to hinder discernment of the voice waves 201. A signal generated by the noise generator 206 is provided to the front speaker 208 to generate acoustic noise waves 203 that may correspond to the inverse input signal, the additional noise sounds, or a combination of the inverse input signal and the additional noise sounds. In this manner, the voice waves 201 may sound different than originally generated by the source, such as quieter or garbled, when received in combination with the noise waves 203.

The front speaker 208 may be coupled to the boom 202 on an opposing side of the boom 202 with respect to the first microphone 204. The front speaker 208 may be orientable in a direction of the first input acoustic wave associated with the first audio source. For example, the front speaker 208 may be oriented in an orthogonal direction of the voice input waves 201 such that the noise output waves 203 are projected in substantially the same direction as the voice input waves 201. For another example, the speaker 208 may include a rotational mechanism to allow the speaker 208 to swivel or otherwise become substantially angled towards a direction determined by signal analyzer circuitry that identifies the direction of the source of a sound. In this manner, the noise generator 206 may cause the front speaker 208 to generate a first output acoustic wave that is inversely related to the first input acoustic wave such that the first output acoustic wave moves in the substantially same direction as the direction of the first input acoustic wave.

The I/O circuit 210 may be located in the housing as part of the headphones 220. The I/O circuit 210 is coupled to the first microphone 204 and the noise cancellation circuit 212. The I/O circuit 212 may cause a second speaker (such as left speaker 226 or right speaker 228) to generate audio (e.g., acoustic waves) based on an output signal provided over a communication channel via the 10 circuit 210.

The noise cancellation circuit 212 is coupled to a second microphone and a second speaker, such as microphone 216 and left speaker 226. The noise cancellation circuit 212 may include circuitry or a combination of circuitry and executable instruction to modify an input signal to reduce audible effects with respect to input received by the second microphone (e.g. microphone 216) and the first output acoustic wave (e.g., noise acoustic waves 203) and cause the second speaker (e.g., the left speaker 226) to generate a second output acoustic wave based on the modified second input signal. For example, the noise cancellation circuit may be a digital signal processor programmed to perform a noise reduction operation on a digital signal. The noise cancellation circuit 212 may operate both left speaker and microphone combination and the right speaker and microphone combination in a similar fashion.

The noise cancellation circuit 212 may be directly electrically connected to the noise generator 206. Direct electrical connection may ensure or improve sound fidelity, as examples. The noise cancellation circuit 212 may receive, from the noise generator 206, a noise signal that adds sound to the first output acoustic waves and performs a modification of a second input signal by reduction of audible effects of the noise signal in the generation of the second output acoustic wave (e.g., the acoustic waves generated from the left speaker 226 and/or right speaker 228).

The noise cancellation circuit 212 may be coupled to the first microphone 204, a second microphone 216, and a third microphone 218. The noise cancellation circuit 212 may be coupled to the front speaker 208, the left speaker 226, and the right speaker 228. The noise cancellation circuit 212 may include signal analyzer circuitry to perform a noise control operation to reduce noise identified from each of the microphones 204, 216, and 218 from being replicated by the left speaker 226 and/or the right speaker 228. By directly connecting the noise cancellation circuit 212 to the front speaker 208, the signal used to generate the sound from the front speaker 208 may be used directly by the noise cancellation circuit 212 to generate a signal for the left and/or right speakers 226 and 228 to produce sound with the signal from the front speaker 208 cancelled out.

Some of the components discussed herein are described as a combination of circuitry and executable instructions. Such combinations may include a processor resource and a memory resource where the memory resource includes the instructions (executable by the processor resource) stored thereon. The set of instructions are operable to cause the processor resource to perform operations of the system 200 when the set of instructions are executed by the processor resource. For example, the functionality described with respect to the noise generator 210 may be performed when a processor resource that enables signal generation by fetching, decoding, and executing instructions stored on a memory resource. The instructions residing on a memory resource may comprise any set of instructions to be executed directly (such as machine code) or indirectly (such as a script) by a processor resource.

Example processor resources include at least one central processor unit (CPU), a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). A processor resource may include multiple processing elements that are integrated in a single device or distributed across devices. A processor resource may process the instructions serially, concurrently, or in partial concurrence.

A memory resource represents a medium to store data utilized and/or produced by the system 200. The medium is any non-transitory medium or combination of non-transitory media able to electronically store data, such as modules of the system 200 and/or data used by the system 200. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. A memory resource may be a non-volatile memory resource such as read-only memory (ROM), a volatile memory resource such as random-access memory (RAM), a storage device, or a combination thereof. Example forms of a memory resource include static RAM (SRAM), dynamic RAM (DRAM), electrically erasable programmable ROM (EEPROM), flash memory, or the like. A memory resource may include integrated memory such as a hard drive (HD), a solid-state drive (SSD), or an optical drive. A memory resource may be said to store program instructions that when executed by a processor resource cause the processor resource to implement functionality of the system 200 of FIG. 2. A memory resource may be integrated in the same device as a processor resource or it may be separate but accessible to that device and the processor resource. A memory resource may be distributed across devices.

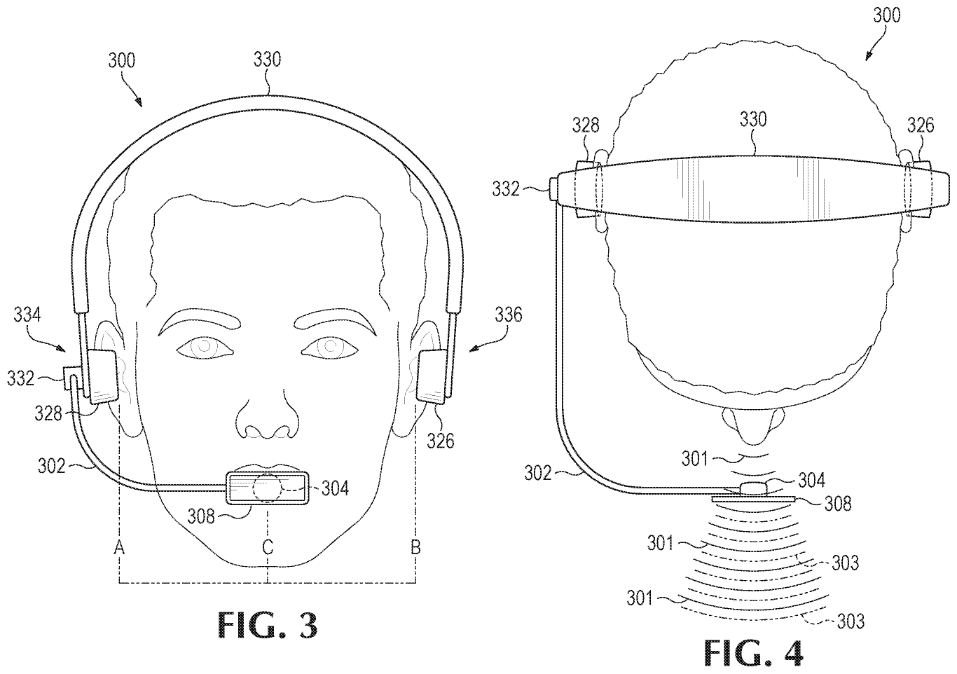

FIG. 3 is a front view of an example audio system 300 worn by a user. The example audio system 300 generally includes a head strap 330, earphones 326 and 328, a boom arm 302, a microphone 304, and a speaker 308. The descriptions of the boom arms 102 and 202, microphones 104 and 204, and speakers 208, 226, and 228 of FIGS. 1 and 2 may be applicable to respective components of the boom arms 302 and 402, the microphones 304 and 404, the speakers 308 and 408, and the earphones 326, 328, 426, and 428, and such descriptions are not repeated in their entirety for brevity.

The head strap 330 represents a support structure of a form factor that is capable of maintaining the audio system 300 in place on the user's head while the user's head is upright. For example, the head strap may be a curved strap that goes over the top of the head of the user. In other examples, the head strap may go around the back of the head of the user. The head strap 330 may have a first ear end 334 and a second ear end 336 where the ear ends 334 and 336 support placing pressure on the user's head to maintain the audio system in place and/or connecting to other elements of the audio system and/or, such as the earphones 326 and 328 or a hinge 332 to the boom arm 302. For example, a first speaker 328 may be coupled to the first ear end 334 of the head strap 330 and a second speaker 326 may be coupled to the second ear end 336 of the head strap 330.

The boom arm 302 is coupled to a hinge 332 located at the first ear end 334 of the head strap 330. The boom arm 302 is adjustable such that the opposing end (e.g. the end opposite of where the boom arm 302 is connected to the hinge 332) is positionable to be directly in front of the user's mouth and substantially centered with respect to locations of the earphones 326 and 328. As shown in FIG. 3, a first earphone 328 may be positioned at location A, a second earphone 326 may be positioned at location B, and the microphone 308 (and the speaker 308) may be positioned at location C which is substantially in the center of a horizontal plane between locations A and B.

The speaker 308 is externally facing and on an opposing side of the boom arm 302 with respect to the first microphone 304. The speaker 308 may be in an external facing direction in the substantially same direction as sound produced from the user's mouth, such as shown as covering the user's mouth from the front perspective depicted in FIG. 3.

In an example, the earphones 326 and 328 may be loudspeakers that are placed to generate acoustic waves into the ear canals of the user. In another example, the earphones 326 and 328 may be bone-conducting transducers that sit on bones adjacent the ear and directly vibrate acoustic waves into the bones conducted towards the cochlea of the user. Bone-conducting speakers may be preferable for producing acoustic waves from a confidential teleconferencing service because the bone-conducting speakers may allow for hearing environmental noises around the user (such as the sounds of a person nearby) through the ear canals as well as receive audio from the teleconferencing service through the skull bones directly to the cochlea.

FIG. 4 is a top view of the example audio system 300 of FIG. 3. As shown in FIG. 4, the microphone 304 may be coupled to the boom arm 302 at an opposing end with respect to the hinge 332 and the speaker 308 is coupled to the same opposing end of the boom arm 302. The speaker 308 is located on an opposing side of the same end of the boom arm 302 with respect to the microphone 304, such that the front speaker 308 is facing away from the face of the user and the microphone 304 is coupled to the other side of the front speaker 308 and facing towards the face of the user. In this manner, the speaker 308 may face away from the user's mouth to generate sound in a same direction as the sound waves produced by the user's mouth. The speaker 308 is centrally located with respect to a left ear support and a right ear support (e.g. centrally located with respect to the left earphone and the right earphone) and vertically located below the user's ears to be placed substantially near the user's mouth.

The microphone 304 is placed substantially in the direction of voice acoustic waves 301 produced from a user's mouth. The speaker 308 is located on the opposing side of the boom arm 302 to produce output acoustic waves 303 in the substantially same direction as the voice acoustic waves 301. The boom arm 302 may include a noise generator coupled to the front speaker 308 to generate an output signal to cause the sound generated by the front speaker 308 to include an inverse wave of the sound waves produced by the user's mouth

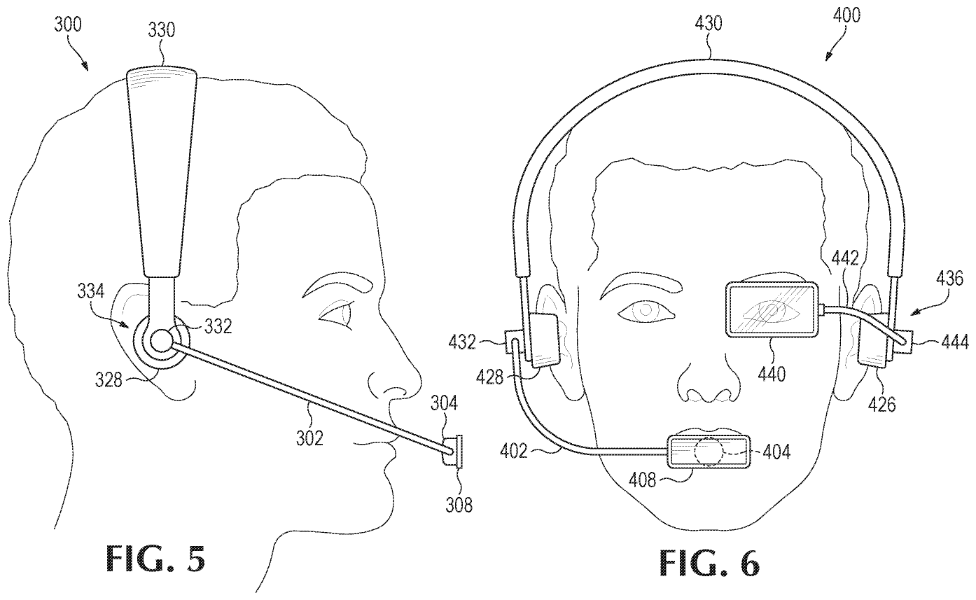

FIG. 5 is a side view of the example audio system 300 of FIG. 3. The hinge 332 couples the boom arm 302 to an end of the head strap 330 near the speaker 328 and allows the boom arm 302 to rotate the microphone 304 and speaker 308 to an appropriate vertical height, such as a vertical height to best capture the voice of the user as an example. The microphone 304 is facing towards the user's mouth and located at substantially the same vertical height as the user's mouth. The speaker 308 is facing away from the user's mouth and located at substantially the same vertical height as the user's mouth (and substantially the same vertical height as the microphone 304).

FIG. 6 is a front view of an example audio system 400 worn by a user. The example audio system 400 generally includes the same components as the example audio system 400 and, for brevity, the descriptions of such elements are not provided in their entirety. Such components include the head strap 430, the earphones 426 and 428, the hinge 432, the boom arm 402, the front, user-facing microphone 404, and the front, externally-facing speaker 408. Additional components not included in the discussion of the example audio system 300 include a display 440, a second boom arm 442, and a second hinge 444.

The second boom arm 442 may be similar in fashion to the first boom arm 402. The second boom arm 442 is coupled to the second hinge 444 located at the second ear end 436 of the head strap 400. The second hinge 444 allows the boom arm 442 to rotate with respect to the second ear end (e.g., rotate with respect to the second earphone 426) and allows the boom arm 442 to be located an appropriate vertical level for the user, such as to allow the display 440 to be located in front of an eye of the user.

The display 440 is coupled to the second boom arm 442 at an opposing end with respect to the second hinge 444. The display 440 is an electronic device capable of presenting content visually. The display 440 may be of any type of display technology to present imagery. Example displays may include a screen such as a liquid crystal display (LCD) panel, an organic light-emitting diode (OLED) panel, a micro light emitting diode (μLED), or other display technology. In some examples, a display device may also include circuitry to operate the screen, such as a monitor scaler.

The display 440 may be operated based on a service that the headset 400 is connected to (e.g., via a host device that is wirelessly connected to the headset 400). For example, the display 440 may present visual imagery associated with a video conferencing service. For another example, the display 440 may present imagery associated with an application that coordinates input received by the microphone 408. In this manner, the user may have a private conversation with both audio input from a remote person through the earphones 426 and 428 as well as visual input from a remote person through the display 440 where both the audio input and the visual input may be kept private to the user of the audio system 400.

All the features disclosed in this specification (including any accompanying claims, abstract and drawings), and/or all the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature described as based on some stimulus may be based only on the stimulus or a combination of stimuli including the stimulus. The article “a” as used herein does not limit the element to a single element and may represent multiples of that element. Furthermore, use of the words “first,” “second,” or related terms in the claims are not used to limit the claim elements to an order or location, but are merely used to distinguish separate claim elements.

The present description has been shown and described with reference to the foregoing examples. It is understood that other forms, details, and examples may be made without departing from the spirit and scope of the following claims.

What is claimed is:

1. An audio system comprising:
a boom arm;
a microphone coupled to the boom arm, the microphone to generate an input signal based on audio input;
a noise generator electrically coupled to the microphone, the noise generator to generate an inverse audio signal corresponding to the input signal generated by the microphone;
a speaker electrically coupled to the noise generator and located on a same end of the boom arm as the microphone, the speaker to generate an acoustic wave based on the inverse audio signal; and
an input/output (I/O) circuit coupled to the microphone, the I/O circuit to send the input signal over a communication channel.

2. The audio system of claim 1, wherein:
the speaker is centrally located with respect to a left ear support and a right ear support; and
the speaker is located on an opposing side of the same end of the boom arm with respect to the microphone.

3. The audio system of claim 1, wherein the noise generator includes:
an amplifier; and
a signal analyzer to identify an acoustic wave characteristic associated with the input signal over a period of time.

4. The audio system of claim 1, wherein:
the speaker is to generate an audible sound that is different from the input signal and the acoustic wave, the audible sound to be louder than the decibel level of the input signal.

5. An apparatus comprising:
a boom arm;
a first microphone coupled to the boom arm, the first microphone to generate a first input signal based on a first input acoustic wave generated from a first audio source;
a first speaker coupled to the boom arm on an opposing side of the boom arm with respect to the first microphone, the first speaker orientable in a direction of the first input acoustic wave associated with the first audio source;
a noise generator coupled to the first speaker, the noise generator to cause the first speaker to generate a first output acoustic wave that is inversely related to the first input acoustic wave such that the first output acoustic wave moves in a substantially same direction as the direction of the first input acoustic wave;
a noise cancellation circuit coupled to a second microphone and a second speaker, the noise cancellation circuit to:
modify a second input signal to reduce audible effects with respect to a third input of the second microphone and the first output acoustic wave; and
cause the second speaker to generate a second output acoustic wave based on the modified second input signal.

6. The apparatus of claim 5, wherein the first output acoustic wave is an audible sound having a decibel level above a decibel level threshold associated with the first input acoustic wave, the first input signal amplified using an amplifier.

7. The apparatus of claim 5, further comprising:
an input/output (I/O) circuit coupled to the first microphone and the noise cancellation circuit, the I/O circuit to cause the second speaker to generate audio based on an output signal provided over a communication channel via the I/O circuit.

8. The apparatus of claim 5, wherein:
the noise generator includes executable instructions to cause a signal analysis operation to perform on the first input signal.

9. The apparatus of claim 5, wherein:
the noise cancellation circuit is directly electrically connected to the noise generator;
the noise cancellation circuit receives, from the noise generator, a noise signal that adds sound to the first output acoustic wave; and
the modification of the second input signal includes reduction of audible effects of the noise signal in the generation of the second output acoustic wave.

10. The apparatus of claim 5, wherein:
the noise cancellation circuit is directly electrically connected the front speaker;
the noise cancellation circuit receives an output signal corresponding to what is played by the first speaker; and
the modification of the second input signal includes removal of audible effects of the output signal in the generation of the second output acoustic wave.

11. A headset comprising:
a head strap having a first ear end and a second ear end;
a first speaker coupled to the first ear end of the head strap and a second speaker coupled to the second ear end of the head strap;
a first boom arm coupled to a first hinge located at the first ear end of the head strap;
a first microphone coupled to the first boom arm at an opposing end with respect to the first hinge;
a third speaker coupled the opposing end of the first boom arm, the speaker to face away from a user's mouth to generate sound in a substantially same direction as sound waves produced by the user's mouth; and
a noise generator coupled to the third speaker to generate an output signal to cause the sound generated by the third speaker to include an inverse wave of the sound waves produced by the user's mouth.

12. The headset of claim 11, wherein:
the first boom arm is adjustable such that the opposing end is positionable to be directly in front of the user's mouth and substantially centered with respect to locations of the first speaker and the second speaker, the third speaker being externally facing and on an opposing side of the first microphone such that the external facing direction is in the same direction as sound produced from the user's mouth.

13. The headset of claim 11, wherein:
the first speaker and the second speaker are bone-conducting transducers; and
the third speaker is an electroacoustic transducer.

14. The headset of claim 11, further comprising:
a second microphone associated with the first speaker;
a third microphone associated with the second speaker; and
a noise cancellation circuit coupled to the first speaker and the second speaker, the noise cancellation circuit to cause reduction of audio effects from audio input associated with the first, second, and third microphones and audio output from the third speaker.

15. The headset of claim 11, further comprising:
a second boom arm coupled to a second hinge located at the second ear end of the head strap; and
a display coupled to the second boom arm at an opposing end with respect to the second hinge, the display to present imagery associated with an application that coordinates input received by the first microphone.
